(19) United States
(12) Patent Application Publication
(10) Pub. No.: US 2016/0123486 A1
(43) Pub. Date: May 5, 2016

(54) RELIEF VALVE

(71) Applicant: EMERSON PROCESS MANAGEMENT REGULATOR TECHNOLOGIES, INC., McKinney, TX (US)

(72) Inventors: Joshua Logan Tecson, Colleyville, TX (US); Roy Ronald Pelfrey, Sherman, TX (US)

(21) Appl. No.: 14/548,028

(22) Filed: Nov. 19, 2014

Related U.S. Application Data
(60) Provisional application No. 62/073,349, filed on Oct. 31, 2014.

(51) Int. Cl. F16K 17/04; F16K 27/02

(52) U.S. Cl. CPC F16K 17/0433; F16K 17/0486; F16K 27/0209

(57) ABSTRACT

A relief valve has a yoke that includes a generally cylindrical body having a first end to engage a body of the relief valve and a second end to receive a guide bushing. A plurality of openings are formed in the body of the yoke to allow fluid flow through the yoke and define a plurality of legs extending between the first end and the second end that are diametrically opposite one of the plurality of openings.

### CROSS-REFERENCE TO RELATED APPLICATIONS

This application claims the benefit of U.S. Provisional Patent Application No. 62/073,349, filed on Oct. 31, 2014, which is incorporated herein by reference in its entirety.

### FIELD OF THE DISCLOSURE

This disclosure relates generally to relief valves and, more specifically, to relief valves used in transport applications.

### BACKGROUND

Relief valves can be used on stationary or mobile storage tanks to keep the tanks from rupturing from excessive tank pressure by venting gas to the atmosphere until the tank pressure drops to an acceptable level.

A typical relief valve 10, such as that shown in FIGS. 1-3, has a generally cylindrical body 20 with a first set of external threads 22, which can be used to connect relief valve 10 to a fluid storage container (not shown), and a second set of external threads 24, which can be used to connect relief valve 10 to an exhaust, rain cap, cover, or other structure. A passageway 26 is formed through body 20 to allow fluid to exhaust from the fluid storage container and through body 20. Passageway 26 forms a shoulder 28 (FIG. 3) that defines a seating surface that engages a sealing assembly 30 when relief valve 10 is in a closed position. A deflector 90 can also be secured to an outer surface of body 20, such as with a drive screw or other well-known means.

Sealing assembly 30 is positioned within passageway 26 and has a bottom disc 32 and a top disc 34. Bottom disc 32 is configured to sealingly engage seating surface 28 of body 20 when relief valve 10 is in the closed position. Top disc 34 has first and second O-rings 36, 38, or other type of seals, set within recesses formed in top disc 34 that engage bottom disc 32. With relief valve 10 in the closed position, bottom disc 32 sealingly engages seating surface 28 of body and first and second O-rings 36, 38 of top disc 34 sealingly engages bottom disc 32 to prevent the flow of fluid through passageway 26. With the relief valve 10 in an open position, bottom disc 32 and top disc 34 will be spaced apart from seating surface 28 of body 20 and fluid will be allowed to flow through relief valve 10.

Stem 40 has a threaded first end 42 that extends through apertures formed in bottom and top discs 32, 34 of sealing assembly 30 and first end 42 of stem 40 is attached to sealing assembly 30 with nut 92 so that stem 40 and sealing assembly 30 move together to move sealing assembly 30 into and out of engagement with seating surface 28. A threaded second end 44 of stem 40 extends through an aperture formed in a spring seat 75 and second end 44 of stem 40 is secured to stem 40 with adjusting nut 94.

Yoke 50 has generally hollow cylindrical body 51 and is secured to body 20 proximate the first set of external threads 22. As can best be seen in FIGS. 2A-2B, openings 56 are formed radially through yoke 50 between first and second ends 52, 54 and define diametrically opposed legs 58 on opposite sides of yoke 50.

Guide bushing 60 is secured to yoke 50 at second end 54 of body 51 and has a body 62 that is inserted into second end 54 of yoke 50 and a flange 64 that engages the end of yoke 50. First and second extensions 66, 68 extend from either end of body 62 and a bore 69 is formed through body 62, first extension 66, and second extension 68, which receives stem 40.

Spring 70 extends between spring seat 75 and guide bushing 60 in yoke 50 and biases spring seat 75 away from body 20, which in turn biases sealing assembly 30 toward seating surface 28 and relief valve 10 into the closed position. Roll pin 96 and lead wire 98 can also be used to secure the position of nut 94, and thus spring seat 75, once the appropriate tension of spring 70 has been set to prevent tampering with relief valve 10.

A cylindrical stem guide 80 can also be positioned around stem 40 and inside spring 70 to assist in stabilizing spring 70 and guiding stem 40 in a longitudinal direction.

In normal operation, spring 70 is compressed between spring seat 75 and guide bushing 60, which biases spring seat 75 away from body 20. Through stem 40, this also biases relief valve 10 into the closed position by biasing sealing assembly 30 toward seating surface 28 of body 20 and seals sealing assembly 30 against seating surface 28. When the pressure in the storage tank increases above a predetermined pressure and the force exerted on sealing assembly 30 exceeds the spring force of spring 70, sealing assembly 30 lifts off of seating surface 28, and relief valve 10 moves into the open position allowing fluid to discharge through relief valve 10. Fluid discharge initially may be small producing only seepage. As pressure increases and fluid volume discharge continues, a large volume of fluid discharge may occur. When the pressure in the storage tank decreases enough, the spring force of spring 70 closes the sealing assembly 30 back against seating surface 28 stopping further discharge.

When used in a mobile application, such as a transport vehicle as shown in FIG. 6, or other mobile storage tank, relief valve 10 will experience movement and excitation in multiple axes (shown as axes X, Y, and Z in FIG. 6) due to vibration and movement of the tank. Based on the design of typical relief valves 10, most of the stress caused by this vibration and movement is experienced in the yoke 50 of relief valve 10.

However, current 2-Leg yoke designs, such as yoke 50 described above, are highly directionally biased. FIG. 7 shows the section modulus for a typical 2-Leg yoke 50, rotating yoke 50 through 90° to capture all possible configurations of excitation relative to the x-axis. As can be seen in FIG. 7, yoke 50 has a varying section modulus depending on the axis of vibration AV and, therefore, the strength of yoke 50 is highly dependent on the axis of vibration AV. For example, if the axis of vibration AV is through the center of both legs (shown as 90° rotation), yoke 50 has a high section modulus and, therefore, high strength. However, if the axis of vibration AV is parallel to both legs (shown as 0° rotation), yoke 50 has a low section modulus and, therefore, low strength.

Therefore, for mobile applications it would be beneficial to have a relief valve that had a yoke with a more consistent section modulus/strength regardless of the direction of the axis of vibration.

### BRIEF SUMMARY OF THE DISCLOSURE

In accordance with one exemplary aspect of the present invention, a yoke for relief valve comprises a generally cylindrical body having a first end to engage a body of the relief valve and a second end to receive a guide bushing. A plurality of openings are formed in the body of the yoke to allow fluid flow through the yoke and define a plurality of legs extending between the first end and the second end that are each diametrically opposite one of the plurality of openings.

In further accordance with any one or more of the foregoing exemplary aspects of the present invention, a yoke for a relief valve may further include, in any combination, any one or more of the following preferred forms.

In one preferred form, the yoke comprises three openings defining three legs.

In another preferred form, each leg is radially spaced approximately 60° from each adjacent leg.

In another preferred form, each of the plurality of legs has a circumferential width that is approximately one-sixth of a circumference of the yoke.

In another preferred form, each of the plurality of openings has a circumferential width that is equal to approximately one-sixth of the circumference of the yoke.

In another preferred form, a circumferential width of each of the plurality of legs is equal to a circumferential width of each of the plurality of openings.

In another preferred form, a first edge of each of the plurality of legs is diametrically aligned with a first edge of the opposite opening and a second edge of each of the plurality of legs is diametrically aligned with a second edge of the opposite opening.

In accordance with another exemplary aspect of the present invention, a relief valve comprises a body, a sealing assembly, a stem, a yoke, and a spring. The body has a passageway therethrough and defines a seating surface and the sealing assembly is positioned within the passageway. The stem has a first end and a second end, the first end attached to the sealing assembly to move the sealing assembly into and out of engagement with the seating surface and the second end secured to a spring seat. The spring is disposed between the yoke and the spring seat to bias the sealing assembly towards the seating surface. The yoke is secured to the body and comprises a generally cylindrical body having a first end and a second end, the first end secured to the body of the relief valve. A plurality of openings are formed in the body of the yoke to allow fluid flow through the yoke and define a plurality of legs extending between the first end and the second end that are each diametrically opposite one of the plurality of openings.

In further accordance with any one or more of the foregoing exemplary aspects of the present invention, a relief valve may further include, in any combination, any one or more of the following preferred forms.

In one preferred form, the relief valve further comprises a guide bushing secured to the second end of the body of the yoke.

In another preferred form, the spring is disposed between the spring seat and the guide bushing.

In another preferred form, the yoke comprises three openings defining three legs.

In another preferred form, each leg is radially spaced approximately 60° from each adjacent leg.

In another preferred form, each of the plurality of legs has a circumferential width that is approximately one-sixth of a circumference of the yoke.

In another preferred form, each of the plurality of openings has a circumferential width that is equal to approximately one-sixth of the circumference of the yoke.

In another preferred form, a circumferential width of each of the plurality of legs is equal to a circumferential width of each of the plurality of openings.

In another preferred form, a first edge of each of the plurality of legs is diametrically aligned with a first edge of the opposite opening and a second edge of each of the plurality of legs is diametrically aligned with a second edge of the opposite opening.

In another preferred form, the first end of the stem is threaded and the sealing assembly is adjustably attached to the first end of the stem with a nut.

In another preferred form, the second end of the stem is threaded and the spring seat is adjustably secured to the second end of the stem with a nut.

### BRIEF DESCRIPTION OF THE DRAWINGS

FIG. 1 is a side cross-sectional view of a typical internal spring relief valve;

FIG. 2A is a side plan view of a yoke of the typical internal spring relief valve of FIG. 1;

FIG. 2B is a cross-sectional view of the yoke of FIG. 2A taken along line 2B-2B;

FIG. 3 is a partial enlarged view of the internal spring relief valve of FIG. 1;

FIG. 4 is a side cross-sectional view of an example relief valve according to the present invention;

FIG. 5A is a side plan view of a yoke of the relief valve of FIG. 4;

FIG. 5B is a cross-sectional view of the yoke of FIG. 5A taken along line 5B-5B;

FIG. 6 is a perspective view of an exemplary use of the internal spring relief valve of FIG. 1; and

FIG. 7 is a graph depicting the section modulus of the yoke of the internal spring relief valve of FIG. 1 and the example relief valve of FIG. 4 as a function of the angle of vibration.

### DETAILED DESCRIPTION

The example relief valve described herein can be used in any stationary, transport, or mobile application and improves the strength of the relief valve by removing directional bias of the strongest section of the yoke without affecting the flow capacity of the relief valve and providing consistent section modulus/strength to the yoke regardless of the direction of the axis of vibration.

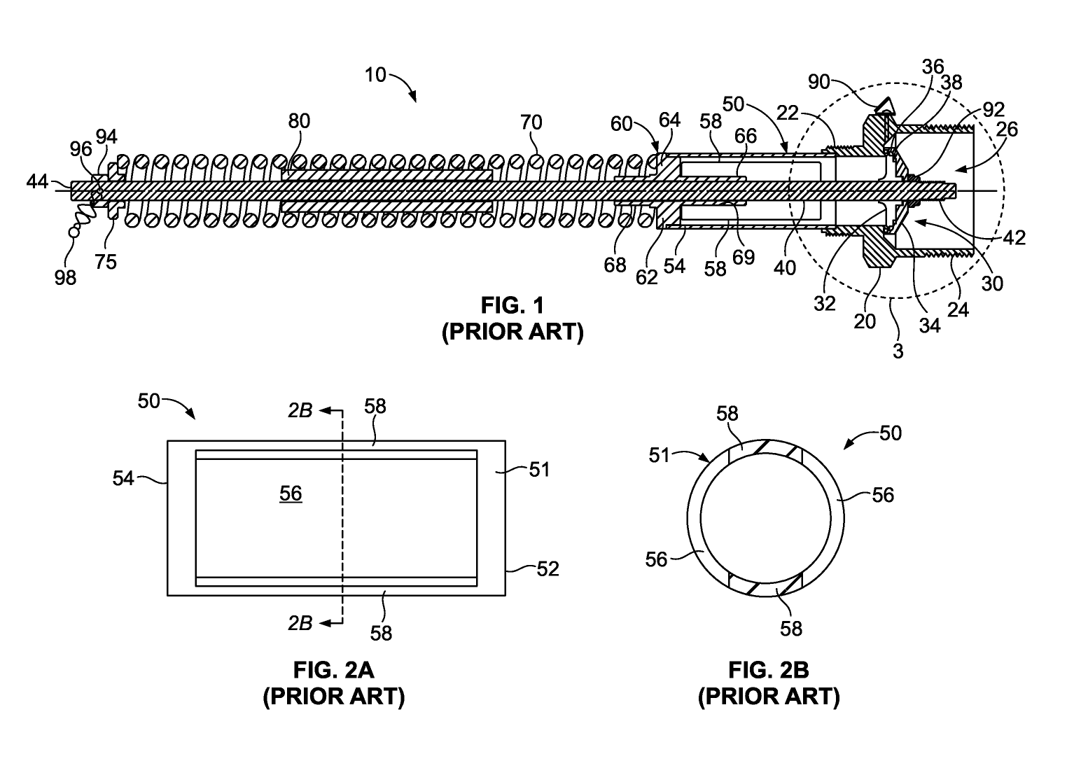

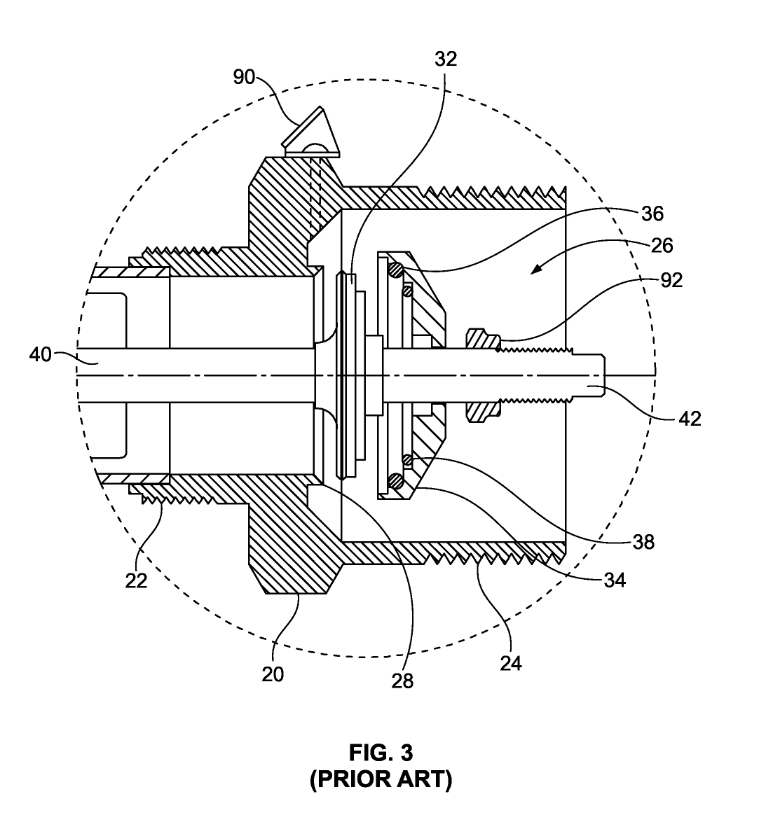

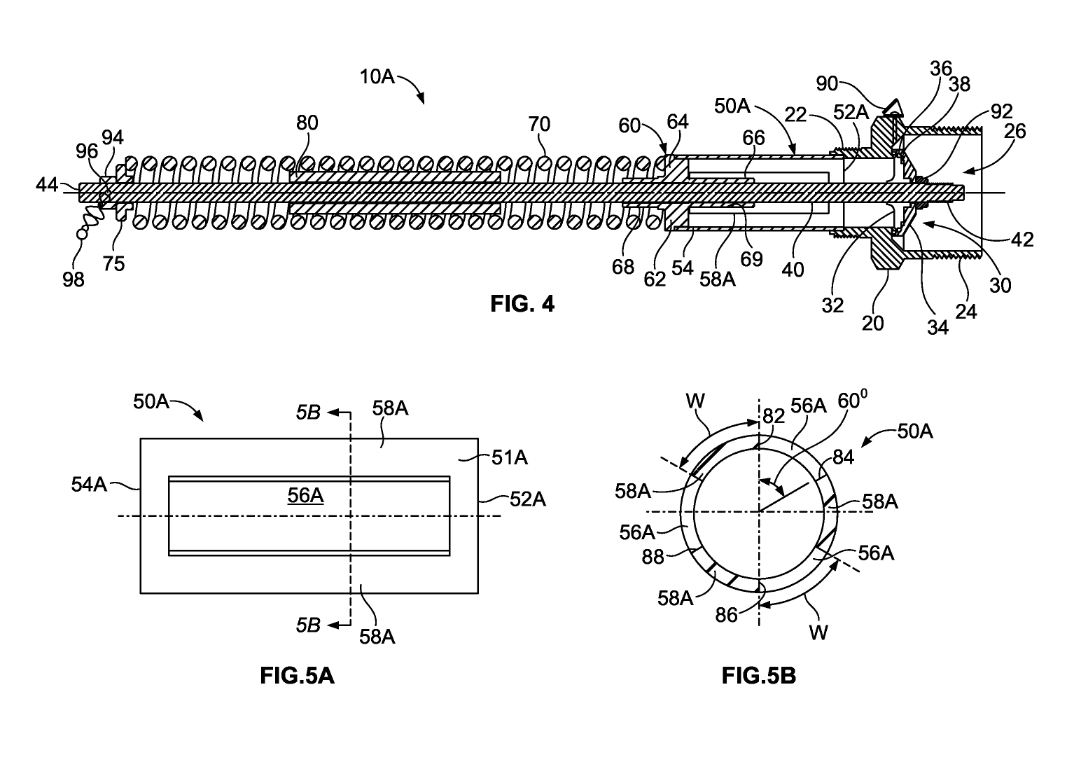

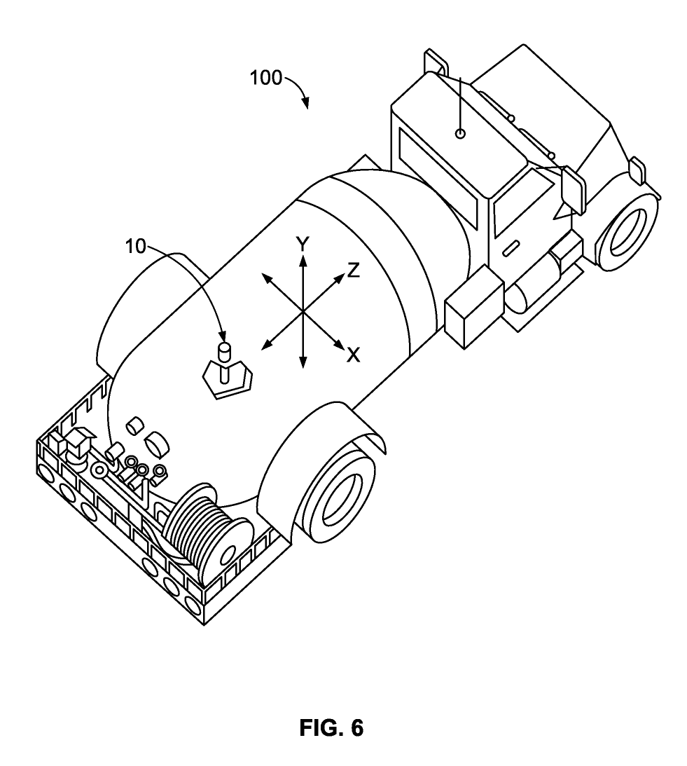

Referring to FIGS. 4, 5A, and 5B, an example relief valve 10A has the same general structure and operation as relief valve 10 of FIGS. 1-3. Common elements between relief valve 10 and relief valve 10A are provided with the same reference numbers and detailed descriptions of these common elements can be found above.

The main difference between relief valve 10 and relief valve 10A is in the design of yoke 50A. In relief valve 10A, yoke 50A has a generally hollow cylindrical body 51 having first and second ends 52A, 54A. First end 52A engages and is secured to body 20 proximate the first set of external threads 22 and second end 54A receives guide bushing 60. As can best be seen in FIGS. 5A-5B, openings 56A are formed radially through yoke 50A to provide fluid communication through yoke 50A between the storage tank and the passageway 26 in body 20 of relief valve 10A.

Forming openings 56A through yoke 50A defines a number of legs 58A that extend between first end 52A and second end 54A of yoke 50A. In the example shown, yoke 50A has three legs 58A and three openings 56A, but can have any odd number of legs 58A and openings 565A, as discussed in more detail below.

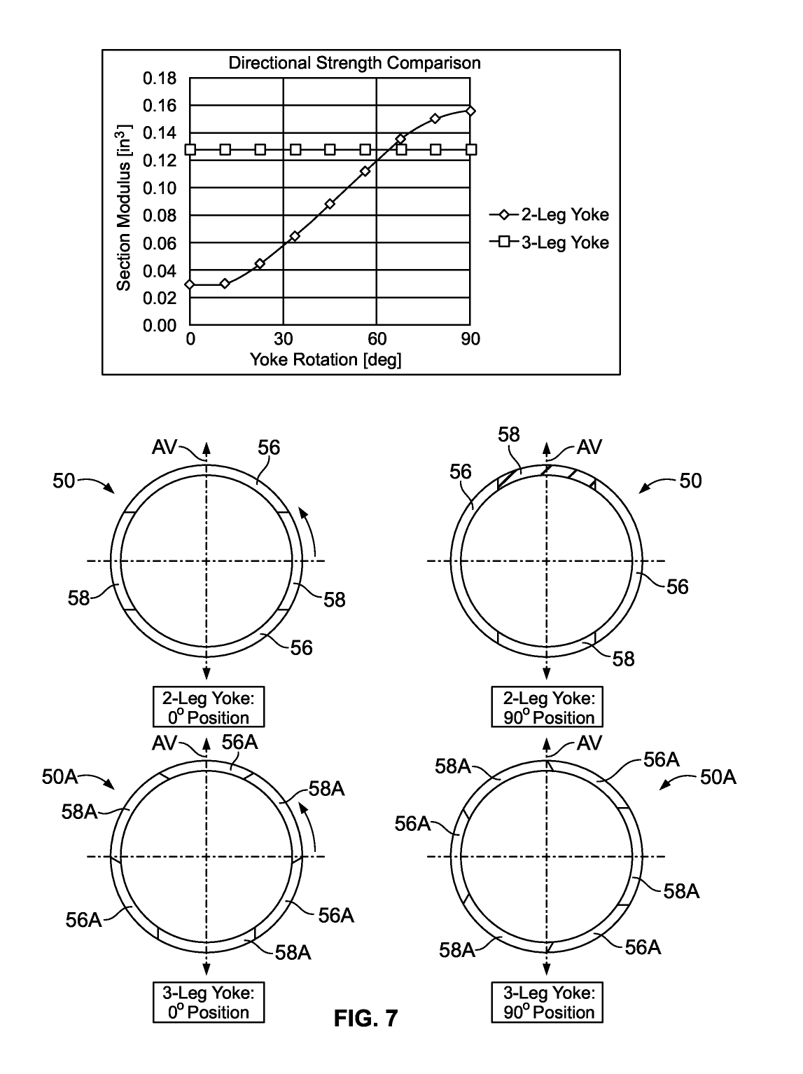

As can best be seen in FIGS. 5B and 7, openings 56A and legs 58A are of equal circumferential size and are arranged around the circumference of yoke 50A such that each leg 58A is diametrically opposed to an opening 56A in all positions. Therefore, in the example shown, each leg 58A and each opening 56A has a circumferential width W of approximately ⅙ of the circumference of yoke 50A and each leg 58A is radially spaced approximately 60° from each adjacent leg 58A. In addition, a first edge 86 of each leg 58A is diametrically aligned with a first edge 82 of the opposite opening 56A and a second edge 88 of each leg 58A is diametrically aligned with a second edge 84 of the opposite opening 56A.

Positioning legs 58A such that a leg 58A is always diametrically opposed to an opening 56A ensures that at least one leg 58A is always supporting yoke 50A and removes the directional bias in the section modulus and strength of yoke 50A. No matter which axis stress is applied to yoke 50A, yoke 50A will have constant strength properties. As shown in FIG. 7, yoke 50A has a constant section modulus regardless of the axis of vibration AV and, therefore, the strength of yoke 50A is not dependent on the axis of vibration AV. Therefore, yoke 50A (the 3-Leg yoke) is directionally unbiased, while the strength of yoke 50 (the 2-Leg yoke) is highly dependent on the axis of vibration AV.

While the example yoke 50A described herein has three legs 58A, a yoke can also have any number of legs 58A as desired, as long as each leg 58A is diametrically opposed to an opening 56A as described above. For example, a yoke can have five legs, each having a circumferential length of approximately 1/10 of the circumference of the yoke, and each leg can be radially spaced approximately 36° from each adjacent leg. This again would ensure that each leg is diametrically opposed to an opening and would provide a constant section modulus/strength to the yoke regardless of the axis of vibration.

While various embodiments have been described above, this disclosure is not intended to be limited thereto. Variations can be made to the disclosed embodiments that are still within the scope of the appended claims.

What is claimed is:

1. A yoke for a relief valve, comprising:
a generally cylindrical body having a first end configured to engage a body of the relief valve and a second end configured to receive a guide bushing; and
a plurality of openings formed in the body of the yoke to allow fluid flow through the yoke and defining a plurality of legs extending between the first end and the second end; wherein
each of the plurality of legs is diametrically opposite one of the plurality of openings.

2. The yoke of claim 1, wherein the yoke comprises three openings defining three legs.

3. The yoke of claim 2, wherein each leg is radially spaced approximately 60° from each adjacent leg.

4. The yoke of claim 1, wherein each of the plurality of legs has a circumferential width that is approximately one-sixth of a circumference of the yoke.

5. The yoke of claim 4, wherein each of the plurality of openings has a circumferential width that is equal to approximately one-sixth of the circumference of the yoke.

6. The yoke of claim 4, wherein each of the plurality of legs is radially spaced approximately 60° from each adjacent leg.

7. The yoke of claim 1, wherein a circumferential width of each of the plurality of legs is equal to a circumferential width of each of the plurality of openings.

8. The yoke of claim 7, wherein a first edge of each of the plurality of legs is diametrically aligned with a first edge of the opposite opening and a second edge of each of the plurality of legs is diametrically aligned with a second edge of the opposite opening.

9. A relief valve, comprising:
a body having a passageway therethrough and defining a seating surface;
a sealing assembly positioned within with passageway;
a stem having a first end and a second end, the first end of the stem attached to the sealing assembly to move the sealing assembly into and out of engagement with the seating surface and the second end of the stem secured to a spring seat;
a yoke secured to the body; and
a spring disposed between the yoke and the spring seat to bias the sealing assembly towards the seating surface; wherein the yoke comprises:
a generally cylindrical body having a first end and a second end, the first end of the body of the yoke secured to the body of the relief valve; and
a plurality of openings formed in the body of the yoke to allow fluid flow through the yoke and defining a plurality of legs extending between the first end and the second end; wherein
each of the plurality of legs is diametrically opposite one of the plurality of openings.

10. The relief valve of claim 9, further comprising a guide bushing secured to the second end of the body of the yoke.

11. The relief valve of claim 10, wherein the spring is disposed between the spring seat and the guide bushing.

12. The relief valve of claim 9, wherein the yoke comprises three openings defining three legs.

13. The relief valve of claim 12, wherein each leg is radially spaced approximately 60° from each adjacent leg.

14. The relief valve of claim 9, wherein each of the plurality of legs has a circumferential width that is approximately one-sixth of a circumference of the yoke.

15. The relief valve of claim 14, wherein each of the plurality of openings has a circumferential width that is equal to approximately one-sixth of the circumference of the yoke.

16. The relief valve of claim 14, wherein each of the plurality of legs is radially spaced approximately 60° from each adjacent leg.

17. The relief valve of claim 9, wherein a circumferential width of each of the plurality of legs is equal to a circumferential width of each of the plurality of openings.

18. The relief valve of claim 17, wherein a first edge of each of the plurality of legs is diametrically aligned with a first edge of the opposite opening and a second edge of each of the plurality of legs is diametrically aligned with a second edge of the opposite opening.

19. The relief valve of claim 9, wherein the first end of the stem is threaded and the sealing assembly is adjustably attached to the first end of the stem with a nut.

20. The relief valve of claim 9, wherein the second end of the stem is threaded and the spring seat is adjustably secured to the second end of the stem with a nut.
